(19) United States
(12) Patent Application Publication
(10) Pub. No.: US 2008/0206586 A1
(43) Pub. Date: Aug. 28, 2008

(54) PENETRATION WELDING METHOD OF T-TYPE JOINT AND PENETRATION WELDING STRUCTURE OF T-TYPE JOINT

(76) Inventors: Shoji Imanaga, Hitachi (JP); Eiji Ashida, Hitachiota (JP); Takeshi Obana, Hitachinaka (JP); Shoh Tarasawa, Hitachinaka (JP); Hiroo Koide, Hitachiota (JP); Toshimitsu Mori, Hitachinaka (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 12/016,408

(22) Filed: Jan. 18, 2008

(30) Foreign Application Priority Data
Feb. 28, 2007 (JP) 2007-048352
May 23, 2007 (JP) 2007-136285

(51) Int. Cl. B32B 15/01; B23K 9/167; B23K 9/00

(52) U.S. Cl. 428/598; 219/75; 219/137 R

(57) ABSTRACT

An upper plate is arranged on the top surface of a lower vertical plate to form a T-type joint, and a penetration promoter is applied on the surface of the upper plate of the T-type joint. Subsequently, when performing non-consumable electrode arc welding, a penetration width w of a molten pool on the side of the vertical plate after penetrating through the back side of the vertical plate is formed equal to or greater than the vertical plate thickness if a lower vertical plate thickness is the same thickness as an upper plate thickness or thinner than the upper plate thickness, and the penetration width of the molten pool is formed equal to or greater than the upper plate thickness if the lower vertical plate thickness is thicker than the upper plate thickness, thereby forming a penetration shape having a desired welding metal part.

### CLAIM OF PRIORITY

The present application claims priority from Japanese application serial No. 2007-048352, filed on Feb. 28, 2007, and Japanese application serial No. 2007-136285, filed on May 23, 2007, the contents of which are hereby incorporated by reference into this application.

### FILED OF THE INVENTION

The present invention relates to a penetration welding method of a T-type joint and a penetration welding structure of a T-type joint made of stainless steel or low carbon steel.

### BACKGROUND OF THE INVENTION

Conventionally, a penetration welding method of a T-type joint using a high energy density electron beam or a laser beam has been proposed.

For example, Patent Document 1 discloses a penetration welding method of a T-type joint in which the surface of a lower plate in contact with an upper plate is formed concavely, an electron beam is directed from the upper plate surface, and the concave part receives the welding metal of the upper plate.

Patent Document 2 discloses a welding method and a structure bonded by the welding method that are targeted at a vehicle body frame, in which a joining part of a member abuts another member having a substantially tabular part serving as a joining part, and a penetration welding process is performed using predetermined penetration welding means (laser welding means and electron beam welding means) from a member surface opposite the surface to which the member abuts.

Meanwhile, a welding method of penetration and a welding joint using a penetration promoter (for example, fluxing agent), and a welding method of penetration using an oxidized gas are known in the art.

For example, Patent Document 3 discloses a welding method in which a penetration promoter, a mixture of a metal oxide powder and a solvent, is applied on a stainless steel base material surface, and then TIG welding is performed.

Patent Document 4 discloses a TIG welding method in which a flux cored wire that includes a flux containing 6 mass % or more of metal oxide is used as a filler material, and TIG welding is performed while supplying the metal oxide into molten metal at 0.05 to 3.0 g/minute.

Patent Document 5 discloses a TIG welding apparatus and a method in which welding is performed while pouring a first shielding gas made of an inert gas toward a workpiece so as to surround an electrode, and pouring a second shielding gas containing an oxidized gas toward the workpiece on the periphery of the first shielding gas.

Patent Document 6 discloses a TIG welding method in which an arc is generated on the center line of a second member on a groove surface of a first member, and welding is performed while providing an alternating magnetic field to the welding part.

Patent Document 7 discloses a welding method and welding structure thereof proposed by the present applicant in which melt bonding is performed at least from the front side or the back side of a butt joint to thereby overlapping them on top of each other at the plate thickness midsection or its neighborhood of the joint.

Patent Document 8 discloses the formation of a T-type joint by friction stir welding. More specifically, in Patent Document 8, a groove is arranged on the lower surface of a first workpiece, a second workpiece is engaged to the groove, a friction stir probe is caused to reach the thickness of the second workpiece from the upper surface of the first workpiece, and the friction stir welding is performed on the first workpiece and the second workpiece, thereby forming the T-type joint.

[Patent Document 1] Japanese Patent Laid-Open No. Sho 63 (1988)-203286.

[Patent Document 2] Japanese Patent Laid-Open No. 2003-334680.

[Patent Document 3] Japanese Patent Laid-Open No. 2000-102890.

[Patent Document 4] Japanese Patent Laid-Open No. 2001-219274.

[Patent Document 5] Japanese Patent Laid-Open No. 2004-298963.

[Patent Document 6] Japanese Patent Laid-Open No. Sho 59 (1984)-13577.

[Patent Document 7] Japanese Patent Laid-Open No. 2006-231359.

[Patent Document 8] Japanese Patent Laid-Open No. Hei 11 (1999)-28581.

### SUMMARY OF THE INVENTION

According to the technical concept disclosed in Patent Document 1, melt bonding can be readily performed by melting and penetrating the upper plate through to the lower plate side by electron beam welding, which is difficult in a conventional welding process for the T-type joint member of a thick plate. However, the technique requires special environmental installations such as a vacuum device that removes the atmosphere and a large vacuum chamber for housing a member for welding, resulting in a sharp rise in the manufacturing costs associated with new investments.

Furthermore, according to Patent Document 1, the penetration welding by the electron beam forms a keyhole-type penetration shape whose penetration width is extremely narrow such that the welding cross-sectional area is small, and only the strength lower than the plate thickness strength of the member can be obtained. The keyhole-type penetration welding also tends to generate spatter (dispersion of molten metal).

According to the technical concept disclosed in Patent Document 2, penetration welding by laser welding or electron beam welding is performed to melt and bond an upper tabular member and a lower member, targeting at a vehicle body frame having a joint structure, which is difficult with conventional arc welding. Particularly, the laser welding is a completely different welding method from the arc welding and is capable of performing the penetration welding because welding is performed by directing a focused, high energy density laser beam onto the member by an optical lens and the like. However, the laser welding forms a keyhole-type penetration shape with a narrow penetration width, so that the welding cross-sectional area correlated with the welding strength tends to be small, and spatter is easily generated during welding. Furthermore, the laser welding requires special installations such as a laser oscillator and is expensive, just like the electron beam, compared to inexpensive arc welding installations. Although Patent Document 2 explicitly states that the electron beam welding can be performed in the same manner as the laser welding, the electron beam welding requires special environmental installations such as a vacuum device that removes the atmosphere and a vacuum chamber that houses a member to be welded. Therefore, as the preparation before welding and exporting after the welding require time, the electron beam welding is not suitable for welding a complex shape that requires movement or rotation of the welding parts.

The technical concept disclosed in Patent Document 3 employs a welding method, targeting at a member of an I-type butt joint and a U-type groove butt joint, in which arc welding from the front surface of a joint member applied with a penetration promoter forms a rear bead on the back surface. Thus, in particular, if a gap exists in the butt joint, or the gap has transformed, the width of the rear bead on the back surface formed by the arc welding significantly changes or sticks out too much. This may degrade the quality of the welded part. Furthermore, the molten pool cannot be retained in the welding of an I-type butt joint having greater than 7 mm plate thickness. Therefore, the welding tends to burn through the back side (for example, surface tension acting on the molten pool<gravity), and the formation of the rear bead without a backing material is difficult. Objects to be welded in Patent Document 3 are the I-type butt joint and the U-type groove butt joint that require formation of the rear beads, which is completely different from the present invention that requires no rear bead formation. In addition, no disclosure or suggestion has been made in Patent Document 3 in relation to the penetration welding of a T-type joint.

According to the technical concept disclosed in Patent Document 4, TIG welding is performed while supplying a predetermined amount of flux cored wires containing 6% or more of metal oxide to obtain a deep penetration part. Specifically, the technical concept indicates a measurement result of the penetration depth in which welding testing of the I-type butt joint having 9 mm plate thickness has been conducted. However, the flux cored wires are vulnerable to humidity which is a major factor of welding defects such as porosity. Thus, the flux cored wires need to be always stored in a special drying room or the like for controlling the quality, which is cumbersome and requires management costs. Another problem is that the penetration depth significantly changes along with the increase and decrease in the feed rate of the flux cored wires, and at the same time, the bead width and the excessive bead height also tend to significantly change. Furthermore, although the test result of the one-side penetration welding from the front surface are disclosed, Patent Document 4 is completely different from the present invention, making no disclosure or suggestion in relation to the penetration welding of a T-type joint.

According to the technical concept disclosed in Patent Document 5, a mixed gas of an oxidized gas (O₂ gas or CO₂ gas) and an inert gas (Ar gas) is poured into the arc welding part to increase the penetration depth. In that case, a penetration promoter is not used. Although Patent Document 5 discloses the relationship of the penetration depth with the oxygen concentration and the carbon dioxide concentration, that is a penetration result from a flat plate different from a joint member. Thus, Patent Document 5 is completely different from the present invention, making no disclosure or suggestion in relation to the penetration welding of a T-type joint.

According to the technical concept disclosed in Patent Document 6, a molten part is stirred while providing an alternate magnetic field during the arc welding to form rear beads on the left and right back sides of the T-type joint. However, a groove is arranged on the upper plate surface, requiring a welding process with a plurality of passes to laminate the upper part of the groove, which is cumber some. Furthermore, in Patent Document 6, use of a special alternate magnetic field device is needed to provide the alternate magnetic field, resulting in a sharp rise in the manufacturing costs associated with new investments.

According to the technical concept disclosed in Patent Document 7, targeting at the I-type butt joint, a deep penetration bonded part with no lack of bonding can be obtained by performing the penetration welding from both of the front surface and the back surface applied with a penetration promoter. However, no specific description is stated indicating that the object to be welded is a T-type joint, and no disclosure or suggestion has been made in relation to the penetration welding of a T-type joint.

According to the technical concept disclosed in Patent Document 8, the formation of the T-type joint is achieved by a friction stir welding method that bonds one workpiece with another workpiece in which the material is in a softened state instead of being melted. The arc welding of the present invention is fundamentally different in that, one workpiece is bonded with another workpiece with the material being melted.

More specifically, in the friction stir welding method, a probe for friction stirring is inserted to perform the friction stir welding to an aluminum joint material, and the solid phase bonding (bonding in a state below the melting point) is performed on the aluminum joint material using the probe. On the other hand, in the arc welding of the present invention, a joint material made of stainless steel or low carbon steel is melt-bonded (bonding in a state above the melting point) using the thermal energy of the arc. Therefore, the bonding methods and the bonding states are completely different.

When determining the patentability, there may be a notion that those skilled in the art can readily conceive the present invention by taking into consideration the technical concept of forming the T-type joint disclosed in Patent Document 8 together with the technical concepts of penetration welding disclosed in Patent Document 2 and Patent Document 3. However, the notion of this combination is not appropriate.

In the friction stir welding method employed in Patent Document 8, aluminum, an aluminum alloy, or the like is used as a joint material. However, when the joint material made of aluminum or aluminum alloy is arc-welded by TIG welding, MIG welding, or the like, large distortion is generated due to the large thermal expansion coefficient. As a result, the distortion is inherent in the welded finished product, and the oxide film generated from the molten metal caused by the arc tends to be rigid with the oxide film reacting with oxygen in the atmosphere. Conventionally, such problems have been solved by using an inert gas as a shielding gas or by removing the generated oxidized film by mechanical means.

Although a certain relationship can be seen between the technical fields of the friction stir welding and the arc welding, as described, various problems arise when the aluminum joint material is arc welded. Thus, it is difficult for those skilled in the art to divert a technology belonging to a different technological field, and it is not readily conceived by those skilled in the art. In other words, the above problems interfere to tie the friction stir welding technique and the arc welding technique, and thus, those skilled in the art cannot readily divert the friction stir welding technique to the arc welding technique.

In the friction stir welding, a filler material, a shielding gas, beveling, and so forth used or conducted in the arc welding are not required, less organizational changes occur to the joining part and its peripheral parts, and the distortion is low. Therefore, the friction stir welding method has in common with the arc welding as a bonding method for bonding workpieces in a broader sense but has completely different characteristics from the arc welding.

As described, it is not readily conceivable or obvious to those skilled in the art to combine Patent Document 8 that discloses the friction stir welding method completely different from the arc welding with Patent Document 2 or Patent Document 3 that discloses welding methods of laser welding, electron beam welding, arc welding, and the like.

Furthermore, even after thorough examination of the problems, knowledge of those skilled in the art, and the like, Patent Document 8 does not disclose or suggest any motivation to apply the friction stir welding method by combining it with other welding methods such as arc welding. More specifically, when determining the patentability by combining the technical concept disclosed in Patent Document 8 with the technical concept disclosed in another patent document or general document, the motivation or suggestion for combining the technical concepts must be stated in Patent Document 8. Combining with another technical concept without stating such motivation or suggestion is not appropriate.

As described, Patent Document 8 discloses a technical concept of the friction stir welding, while Patent Document 2 and Patent Document 3 disclose technical concepts in relation to general welding. As a result, it is not readily conceivable for those skilled in the art to complete the present invention by combining Patent Document 8 with Patent Document 2 or Patent Document 3.

The present invention has been made in view of the foregoing various points, and an object thereof is to provide a penetration welding method of a T-type joint and a penetration welding structure of a T-type joint that do not require formation of a bevel groove or a gap on the upper plate side arranged on the lower vertical plate surface and that are effective in obtaining a sound welding metal part in which up to the lower vertical plate side is melted and bonded by arc welding from the upper plate surface.

In order to attain the object, the present invention provides a penetration welding method of a T-type joint made of stainless steel or low carbon steel that melts and bonds from a single-ply upper plate surface or two upper plate surfaces arranged in parallel in a butted manner on a lower vertical plate surface to a lower vertical plate, wherein when performing non-consumable electrode arc welding after applying a penetration promoter on the upper plate surface, a penetration width w on the vertical plate side after penetrating through the upper plate back side is formed equal to or greater than a vertical plate thickness T2 if the lower vertical plate thickness T2 is the same thickness as an upper plate thickness T1 or thinner than the upper plate thickness T1, or the penetration width w is formed equal to or greater than the upper plate thickness T1 if the lower vertical plate thickness T2 is thicker than the upper plate thickness T1.

The present invention provides a penetration welding method of a T-type joint made of stainless steel or low carbon steel that melts and bonds from a single-ply upper plate surface or two upper plate surfaces arranged in parallel in a butted manner on a lower vertical plate surface to a lower vertical plate, the penetration welding method comprising: an application step of applying a penetration promoter on the upper plate surface in the weld line direction; and a welding step of forming a penetration width w on the vertical plate side after penetrating through the upper plate back side to be equal to or greater than a vertical plate thickness T2 if the lower vertical plate thickness T2 is the same thickness as an upper plate thickness T1 or thinner than the upper plate thickness T1, or forming the penetration width w equal to or greater than the upper plate thickness T1 if the lower vertical plate thickness T2 is thicker than the upper plate thickness T1, when performing non-consumable electrode arc welding from the upper plate surface on which the penetration promoter is applied.

The present invention provides a penetration welding method of a T-type joint made of stainless steel or low carbon steel that melts and bonds from a single-ply upper plate surface or two upper plate surfaces arranged in parallel in a butted manner on a lower vertical plate surface to a lower vertical plate, wherein when performing non-consumable electrode arc welding using shielding gas supply means for discharging a shielding gas made of an inert gas and a shielding gas containing an oxidized gas, a penetration width w on the vertical plate side after penetrating through the upper plate back side is formed equal to or greater than a vertical plate thickness T2 if the lower vertical plate thickness T2 is the same thickness as an upper plate thickness T1 or thinner than the upper plate thickness T1, or the penetration width w is formed equal to or greater than the upper plate thickness T1 if the lower vertical plate thickness T2 is thicker than the upper plate thickness T1.

When using a vertical plate thickness T2 in which the entire surface on the vertical plate side can be bonded, up to surfaces of both sides of the lower vertical plate thickness T2 that is in contact with or in proximity to the upper plate back side are preferably melted to form a penetration shape having a melt-bonded part on both corners of the upper plate back side and the vertical plate joint.

The present invention provides a penetration welding method of a T-type joint made of stainless steel or low carbon steel that melts and bonds from a single-ply upper plate surface or two upper plate surfaces arranged in parallel in a butted manner on a lower vertical plate surface to a lower vertical plate, wherein non-consumable electrode arc welding using the shielding gas supply means for discharging a shielding gas made of an inert gas and a shielding gas containing an oxidized gas is performed from the upper plate surface arranged on a vertical plate surface thicker than the upper plate thickness T1 to form the penetration width w on the vertical plate side after penetrating through the vertical plate back side to be equal to or greater than the upper plate thickness T1.

The present invention provides a penetration welding method of a T-type joint made of stainless steel or low carbon steel that melts and bonds from a single-ply upper plate surface or two upper plate surfaces arranged in parallel in a butted manner on a lower vertical plate surface to a lower vertical plate, wherein non-consumable electrode arc welding is performed after applying a penetration promoter on the upper plate surface arranged on the vertical plate surface thicker than the upper plate thickness T1 to form the penetration width w on the vertical plate side after penetrating through the vertical plate back side to be equal to or greater than the upper plate thickness T1.

The range of the upper plate thickness T1 is preferably set to 2≦T1≦7 mm. The welding deformation tends to increase due to the over melting of the upper plate side if the upper plate thickness T1 is thinner than 2 mm. On the other hand, if the upper plate thickness T1 is thicker than 7 mm, it is hard to melt from the upper plate surface through the back side to the lower vertical plate side and to ensure sufficiently large penetration width w on the vertical plate side. A large-output arc welding apparatus is required to perform forcible melting, and the welding deformation tends to increase due to the over melting of the upper plate side, and thus, the forcible melting is not preferable. The penetration depth h on the vertical plate side that is penetrated and welded at least from the upper plate surface is preferably formed 1 mm or more. Forming the penetration depth h on the vertical plate side that is penetrated and welded from the upper plate surface to be 1 mm or more ensures sufficiently large penetration depth w and welding cross-sectional area on the upper plate side that relate to the welding strength. The molten metal having a predetermined penetration width w is formed in one pass, thereby shortening the welding time and allowing efficient arc welding.

The present invention provides a penetration welding structure of a T-type joint that is made of stainless steel or low carbon steel and that is melted and bonded from a single-ply upper plate surface or two upper plate surfaces arranged in parallel in a butted manner on a lower vertical plate surface to a lower vertical plate, wherein any one of the foregoing penetration welding methods is performed, the penetration welding structure further comprising: a welding metal part in which a penetration width w on the vertical plate side after penetrating through the upper plate back side is formed equal to or greater than the vertical plate thickness T2 if the lower vertical plate thickness T2 is the same thickness as the upper plate thickness T1 or thinner than the upper plate thickness T1; or a welding metal part in which the penetration width w is formed equal to or greater than the upper plate thickness T1 if the lower vertical plate thickness T2 is thicker than the upper plate thickness T1.

In the present invention, the welding cross-sectional area of an upper plate back side penetration part or a penetration width part on the vertical plate side is formed equal to or greater than the plate thickness cross-sectional area on the upper plate side or formed equal to or greater than the plate thickness cross-sectional area on the vertical plate side. This can increase the strength of the junction.

The present invention provides a penetration welding structure of a T-type joint that is made of stainless steel or low carbon steel and that is melted and bonded from a single-ply upper plate surface or two upper plate surfaces arranged in parallel in a butted manner on a lower vertical plate surface to a lower vertical plate, the penetration welding structure further comprising a welding metal part in which non-consumable electrode arc welding is performed after applying a penetration promoter on the upper plate surface arranged on the vertical plate surface thicker than the upper plate thickness T1 to form the penetration width w on the vertical plate side after penetrating through the vertical plate back side to be equal to or greater than the upper plate thickness T1.

The present invention provides a penetration welding method of a T-type joint made of stainless steel or low carbon steel that melts and bonds from a single-ply upper plate surface or two upper plate surfaces arranged in parallel in a butted manner on a lower vertical plate surface to a lower vertical plate, the penetration welding structure further comprising a welding metal part in which non-consumable electrode arc welding using shielding gas supply means for discharging a shielding gas made of an inert gas and a shielding gas containing an oxidized gas is performed from the upper plate surface arranged on a vertical plate surface thicker than the upper plate thickness T1 to form the penetration width w on the vertical plate side after penetrating through the vertical plate back side to be equal to or greater than the upper plate thickness T1.

The range of the upper plate thickness T1 is preferably set to 2≦T1≦7 mm. The penetration depth h on the vertical plate side that is penetrated and welded at least from the upper plate surface is preferably formed 1 mm or more. The welding metal part is preferably formed as a T-type joint applied at least to a nuclear power device or a thermal power device.

More specifically, in the penetration welding method of the present invention, the penetration width w on the vertical plate side after penetrating through the upper plate back side is formed equal to or greater than the vertical plate thickness T2 if the lower vertical plate thickness T2 is the same thickness as the upper plate thickness T1 or thinner than the upper plate thickness T1 when performing the non-consumable electrode arc welding after applying a penetration promoter on the upper plate surface. As a result, the upper plate and the lower vertical plate can be rigidly melted and bonded, the welding cross-sectional area equal to or larger than the plate thickness cross-sectional area on the vertical plate side can be obtained, and the tensile strength equal to or stronger than the vertical plate material strength can be obtained, even if a flat plate T-type joint that is not beveled is used. On the other hand, the penetration width w is formed equal to or greater than the upper plate thickness T1 when the lower vertical plate thickness T2 is thicker than the upper plate thickness T1. As a result, the welding cross-sectional area equal to or larger than the plate thickness cross-sectional area on the upper plate side can be obtained, and the tensile strength equal to or stronger than the upper plate material strength can be obtained.

The application step of applying a penetration promoter on the upper plate surface in the weld line direction enables to uniformly apply a film thickness in the weld line horizontal direction. The film thickness formation with the penetration promoter enables to obtain a symmetric, deep penetration shape without offset during the arc welding.

When performing non-consumable electrode arc from the upper plate surface on which the penetration promoter is applied, the penetration width w on the vertical plate side after penetrating through the upper plate back side is formed equal to or greater than the vertical plate thickness T2 if the lower vertical plate thickness T2 is the same thickness as the upper plate thickness T1 or thinner than the upper plate thickness T1, or the penetration width w is formed equal to or greater than the upper plate thickness T1 if the lower vertical plate thickness T2 is thicker than the upper plate thickness T1. Therefore, as described, the upper plate and the lower vertical plate can be rigidly melted and bonded, either the welding cross-sectional area equal to or larger than the plate thickness cross-sectional area on the vertical plate side or the welding cross-sectional area equal to or larger than the plate thickness cross-sectional area on the upper plate side can be obtained, and the tensile strength equal to or stronger than the vertical plate material strength or the upper plate material strength can be obtained, even if a flat plate T-type joint that is not beveled is used. The non-consumable electrode arc welding is performed after applying the penetration promoter on the upper plate surface arranged on the vertical plate surface thicker than the upper plate thickness T1. As a result, the penetration width w on the vertical plate side after penetrating through the upper plate back side can be formed equal to or greater than the upper plate thickness T1, and as described, the welding cross-sectional area equal to or larger than the plate thickness cross-sectional area on the upper plate side can surely be obtained.

The arc welding of the present invention forms a convection type (and heat conduction type) penetration shape and does not generate spatter (dispersion of molten metal) at all. The arc welding does not require installation of a backing material and does not burn through. Furthermore, the arc welding enables to reduce welding deformation, manpower, and costs, as compared to conventional TIG welding. Especially, the thermal reaction of metal oxide contained in the penetration promoter (for example, chemical reaction in which oxygen dissociates from metal oxide, and much of the dissociated oxygen is dissolved in the molten metal) changes the convection of the molten metal (molten pool) right under the arc into the depth direction and promotes melting. As a result, the penetration depth h becomes deeper. The penetration depth h can be adjusted according to dimensions of the welding heat input conditions such as welding current and welding speed, and appropriate welding heat input conditions are preferably set in advance such that the penetration depth h and the penetration width w are in predetermined ranges corresponding to the plate thickness of a joint member or the welding position. The penetration promoter is made of a fluxing material in which metal oxide powder such as TiO₂, SiO₂, Cr₂O₃, or the like and a solvent are mixed, and a known marketed product can be used.

On the other hand, when the penetration promoter is not used, the non-consumable electrode arc welding is preferably performed using shielding gas supply means (for example, welding torch) with a double shield structure that simultaneously discharges a shielding gas made of an inert gas and a shielding gas containing an oxidized gas. When performing the double shield arc welding, the penetration width w on the vertical plate side after penetrating through the upper plate back side is formed equal to or greater than the vertical plate thickness T2 when the lower vertical plate thickness T2 is the same thickness as the upper plate thickness T1 or thinner than the upper plate thickness T1, and the penetration width w is formed equal to or greater than the upper plate thickness T1 when the lower vertical plate thickness T2 is thicker than the upper plate thickness T1. Therefore, as described, the upper plate and the lower vertical plate can be rigidly melted and bonded, either the welding cross-sectional area equal to or larger than the plate thickness cross-sectional area on the vertical plate side or the welding cross-sectional area equal to or larger than the plate thickness cross-sectional area on the upper plate side can be obtained, and the tensile strength equal to or stronger than the vertical plate material strength or the upper plate material strength can be obtained, even if a flat plate T-type joint that is not beveled is used. The double shield arc welding is performed from the upper plate surface arranged on the vertical plate surface thicker than the upper plate thickness T1. As a result, the penetration width w can be formed equal to or greater than the upper plate thickness T1, and as described, the welding cross-sectional area equal to or larger than the plate thickness cross-sectional area on the upper plate side can surely be obtained.

The arc welding of the present invention forms a convection type (and heat conduction type) penetration shape and does not generate spatter at all. In addition, the arc welding does not require installation of a backing material and does not burn through. Furthermore, the arc welding enables to reduce welding deformation, manpower, and costs, as compared to conventional TIG welding. For example, if the arc welding is performed while pouring a mixed gas of several percent of an oxidized gas (O₂ or CO₂) and an inert gas (Ar or He) into the arc welding part, the convection of the molten metal (molten pool) right under the arc changes in the depth direction to make the penetration depth h deeper, allowing melting and bonding from the upper plate surface to the lower vertical plate side. A known marketed product can be used as the mixed gas of an oxidized gas and an inert gas.

When using a vertical plate thickness T2 in which the entire surface on the vertical plate side can be bonded, up to surfaces of both sides of the lower vertical plate thickness T2 that is in contact with or in proximity to the upper plate back side are melted to form a penetration shape having a melt-bonded part on both corners of the upper plate back side and the vertical plate joint. As a result, there is no non-bonded part on the vertical plate side, thereby enabling to increase the welding cross-sectional area and allowing simple evaluation by visual inspection of the quality of the welding bead appearance on the upper plate front side and the bonded part appearance exposed at the corners on the back side.

Setting up the range of the upper plate thickness T1 to 2≦T1≦7 mm allows melting and bonding from the upper plate surface through the back side to the lower vertical plate side and enables to obtain a welding metal part having a sound penetration shape. If the upper plate thickness T1 is thinner than 2 mm, the welding deformation tends to increase due to the over melting of the upper plate side. On the other hand, if the upper plate thickness T1 is thicker than 7 mm, it is hard to melt from the upper plate surface through the back side to the lower vertical plate side and to obtain a sufficiently large penetration width w on the vertical plate side. A large-output arc welding apparatus is required to perform forcible melting, and the welding deformation tends to increase due to the over melting of the upper plate side, and thus, the forcible melting is not preferable.

Forming the penetration depth h on the vertical plate side that is penetrated and welded at least from the upper plate surface to be 1 mm or more ensures sufficiently large penetration width and welding cross-sectional area on the vertical plate side that relate to the welding strength.

In the penetration welding structure of the present invention, any of the above penetration welding methods is carried out. When the lower vertical plate thickness T2 is the same thickness as the upper plate thickness T1 or thinner than the upper plate thickness T1, comprising a welding metal part in which the penetration width w on the vertical plate side after penetrating through the upper plate back side is formed equal to or greater than the vertical plate thickness T2 enables to obtain a welding structure having a welding cross-sectional area equal to or larger than the plate thickness cross-sectional area on the vertical plate side. On the other hand, when the lower vertical plate thickness T2 is thicker than the upper plate thickness T1, comprising a welding metal part in which the penetration width w on the vertical plate side is formed equal to or greater than the upper plate thickness T1 enables to obtain a welding structure having a welding cross-sectional area equal to larger than the plate thickness cross-sectional area on the upper plate side. The welding cross-sectional area (multiplication of the penetration width and the welding length) of an upper plate back side penetration part or a penetration width part on the vertical plate side is formed equal to or larger than the plate thickness cross-sectional area on the upper plate side or formed equal to or larger than the plate thickness cross-sectional area on the vertical plate side. Thus, a welding metal part and a welding structure having the welding strength of equal to or stronger than the upper plate material strength or the vertical plate material strength can be obtained. Furthermore, as described, setting up of the range of the upper plate thickness T1 to 2≦T1≦7 mm allows melting and bonding from the upper plate surface through the back side to the lower vertical plate side and enables to obtain a welding metal part and a welding structure having a sound penetration shape. In this case, application to a welding structure of a T-type joint incorporated in a nuclear power device or other devices (for example, thermal power device) enables to reduce welding deformation, manpower, and costs, as compared to a conventional weldment.

As has been described, according to the penetration welding method of a T-type joint and the penetration welding structure of a T-type joint of the present invention, a bevel groove or a gap need not be formed on the upper plate side, and one-pass welding with deep penetration can be performed. A welding metal part in which from the upper plate surface to the lower vertical plate side is melted and in which the upper plate and the lower vertical plate are rigidly bonded can be obtained, and welding strength corresponding to the obtained welding cross-sectional area equal to or larger than the upper plate cross-sectional area or the vertical plate cross-sectional can also be obtained. Moreover, installation of a backing material is not required, and no burning through occurs. As a result, welding deformation, manpower, and costs can be reduced as compared to a conventional welding method or a weldment.

### BRIEF DESCRIPTION OF THE DRAWINGS

FIG. 1 is an explanatory view of an embodiment of a welding procedure and a penetration shape according to a penetration welding method of a T-type joint of the present invention;

FIG. 2 is an explanatory view of another embodiment of a welding procedure and a penetration shape according to the penetration welding method of a T-type joint of the present invention;

FIG. 3 is an explanatory view of still another embodiment of a welding procedure and a penetration shape according to the penetration welding method of a T-type joint of the present invention;

FIG. 4 depicts an example of the relationship of the welding current with the penetration width and the penetration depth of each plate thickness on the vertical plate side when applying the welding method shown in FIG. 1 and FIG. 2. Representative cross-sectional photographs of each plate thickness (upper plate thickness T1=3, 4, 6 mm) in which welding is performed by changing the welding current are disclosed in FIG. 4;

FIG. 5 depicts another example of the relationship of the welding current with the penetration width and the penetration depth on the vertical plate side when applying the welding method shown in FIG. 1 and FIG. 2. Representative cross-sectional photographs in which welding is performed by changing the welding speed (50, 65, 80 mm/min) are disclosed in FIG. 5;

FIG. 6 depicts still another example of the relationship of the plate thickness of the T-type joint with the welding current, the penetration width, and the penetration depth when applying the welding method shown in FIG. 1. Representative cross-sectional photographs in which three types of plate thicknesses (3, 4, 6 mm) are welded are disclosed in FIG. 6;

FIG. 7 is a cross-sectional view of a comparative example of a multi-pass welding shape of a T-type joint with a bevel groove in conventional TIG welding;

FIG. 8 is a cross-sectional view of another comparative example of a multi-pass welding shape of a T-type joint with a gap in conventional TIG welding;

FIG. 9 depicts one example of a result of the comparison of the total heat input amount with the contraction deformation amount and the warpage deformation amount when constructed with the welding method of the present invention and with a conventional welding method;

FIG. 10 depicts one example of the tensile result of T-type joint welding specimens (five specimens) having 3 mm upper plate thickness welded with the welding method of the present invention; and

FIG. 11 depicts a fracture specimen photograph after the tensile test shown in FIG. 10.

### DESCRIPTION OF THE PREFERRED EMBODIMENTS

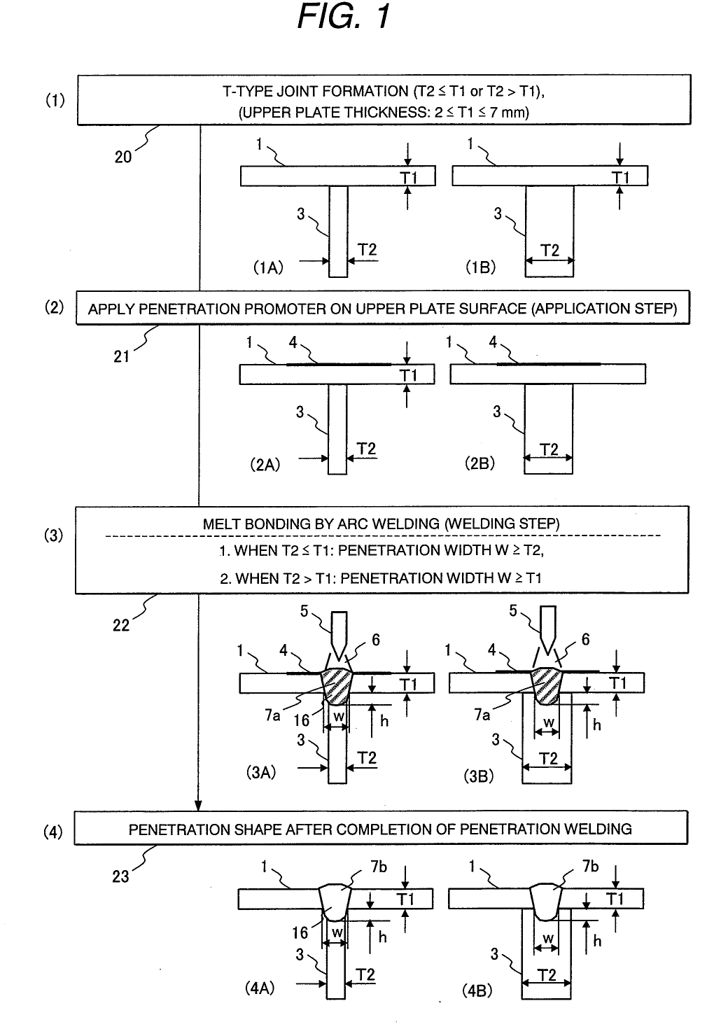

Contents of the present invention will now be specifically described with reference to embodiments shown in FIGS. 1 to 6.

FIG. 1 is an explanatory view of one embodiment of a welding procedure and a penetration shape according to a penetration welding method of a T-type joint of the present invention. As shown in FIG. 1A, a joint to be welded is made of stainless steel or low carbon steel and forms a T-shaped T-type joint with an upper plate 1 and a lower plate 3 (T-type joint formation 20).

More specifically, the upper plate 1 in the horizontal direction is overlaid on the top surface of the lower vertical plate 3 in the vertical direction to construct a T-shape, and the upper plate 1 and the lower vertical plate 3 are melted and bonded. The range of a plate thickness T1 of the upper plate 1 (hereinafter, “upper plate thickness T1”) is 2≦T1≦7 mm, and the upper plate thickness T1 is formed substantially uniformly in the horizontal direction. A plate thickness T2 of the lower vertical plate 3 (hereinafter, “vertical plate thickness T2”) is formed substantially uniformly in the vertical direction.

This embodiment will be described by roughly dividing into a case of a T-type joint in which the lower vertical plate thickness T2 is the same thickness as the upper plate thickness T1 or thinner than the upper plate thickness T1 (T2≦T1) and a case of a T-type joint in which the vertical plate thickness T2 is thicker than the upper plate thickness T1 (T2>T1).

In the following application step 21, as shown in FIG. 1B, a penetration promoter 4 (fluxing material containing metal oxide) is applied to a surface of the upper plate 1 to be welded, using application means (not shown). The penetration promoter is made of a fluxing material in which metal oxide powder such as TiO₂, SiO₂, Cr₂O₃, or the like and a solvent is mixed, and a known marketed product can be used and applied.

The application means includes a brush, a roller, and the like, and a brush is preferably used.

The penetration promoter 4 is preferably applied in the weld line direction on the surface of the upper plate 1 to make the applied film thickness in the weld line horizontal direction an even thickness (for example, 20 μm or more). Use of a brush for the reciprocate application of the penetration promoter 4 in the weld line direction enables to form a desired film thickness in the weld line horizontal direction.

In this case, forming the applied film thickness of the penetration promoter 4 to be 20 μm or more, for example, enables to obtain a substantially symmetric, deep penetration shape without offset or curvature during arc welding. This is especially suitable for forming the penetration depth (T1+h) from the surface of the upper plate 1 to be 7 mm or more. The applied film thickness may be thinner than 20 μm in the case of thin welding that allows a penetration depth of less than 7 mm. The letter h denotes the penetration depth on the side of the vertical plate 3.

When the weld line (welding position) becomes unclear due to the application of the penetration promoter 4 and is hard to visually check, it is preferable to mark in advance a visual line (mark-off line) in parallel with the weld line at the position little apart from the weld line to be welded. With this mark-off line as a marker, the torch positioning or the copy adjustment of the weld line position can be easily conducted during welding.

In the following welding step 22, melting and bonding by non-consumable electrode arc welding is performed from the surface of the upper plate 1 after application, as shown in FIG. 1C. In this arc welding, non-consumable tungsten is used for an electrode 5. When performing the arc welding, melting and bonding is conducted so as to form a penetration width w on the side of the vertical plate 3 after penetrating through the back side of the upper plate 1 to be equal to or greater than a vertical plate thickness T2 (w≧T2) if the lower vertical plate thickness T2 is the same thickness as the upper plate thickness T1 or thinner than the upper plate thickness T1 (T2≦T1). The melting and bonding is conducted so as to form the penetration width w on the side of the vertical plate 3 to be equal to or greater than the upper plate thickness T1 (w>T1) if the lower vertical plate thickness T2 is thicker than the upper plate thickness T1 (T2>T1). Reference numeral 16 denotes an exposed bonding part to be described below.

By melting and bonding in such a manner, the thermal reaction (for example, chemical reaction in which oxygen dissociates from metal oxide, and much of the dissociated oxygen is dissolved in molten metal) of metal oxide contained in the penetration promoter 4 changes the convection of a molten pool 7a right under the arc 6 in the inward direction and in the depth direction to promote melting. As a result, a welding metal part 7b can be obtained in which the back side of the upper plate 1 is penetrated through and deeply melted up to the vertical plate 3, as shown in FIG. 1D. A substantially symmetric, deep penetration shape 23 without offset or curvature can also be obtained on the welding metal part 7b, having sound quality with no porosity.

The penetration depth tends to be shallow if the film thickness of the penetration promoter 4 applied in the weld line direction is extremely thin. The convection is generated in the weld width direction (outward direction) and disturbs the convection in the depth direction (inward direction) if the applied film thickness in the weld line horizontal direction has been greatly changed. Thus, the molten pool 7a becomes asymmetric, spreads toward the side where the film thickness is thin, and becomes offset, and the penetration tends to be shallow due to the distortion. Forming the applied film thickness evenly in the weld line horizontal direction causes the convection of the molten pool 7a to act in the depth direction during arc welding, enabling to obtain the substantially symmetric, deep penetration shape 23 without offset or curvature.

Forming the penetration width w on the side of the vertical plate 3 to be equal to or greater than the vertical plate thickness T2 (w≧T2) or equal to or greater than the upper plate thickness T1 (w≧T1) enables to obtain the welding cross-sectional area (multiplication of the penetration width and the welding length) equal to or larger than the plate thickness cross-sectional area on the side of the vertical plate 3 or the plate thickness cross-sectional area on the side of the upper plate 1, and to obtain the tensile strength equal to or stronger than the vertical plate material strength or the upper plate material strength.

The arc welding forms a convection type (and heat conduction type) penetration shape and does not generate spatter (dispersion of molten metal) at all. The arc welding does not require implementation of a groove on the side of the upper plate 1, does not require installation of a backing material, and does not burn through. Furthermore, the arc welding enables to reduce welding deformation, manpower, and costs, as compared to conventional TIG welding. The penetration width w on the side of the vertical plate 3 can be adjusted according to the dimensions of the welding heat input conditions such as welding current and welding speed. The melting and bonding by the arc welding is preferably performed by setting up appropriate welding conditions so as to form the penetration width w equal to or greater than the upper plate thickness T1 (w≧T1) or equal to or greater than the vertical plate thickness T2 (w≧T2) in accordance with the plate thickness T1 of the upper plate 1 and the plate thickness T2 of the vertical plate 3.

When using a vertical plate thickness T2 (for example, T2≦T1) in which the entire surface on the side of the vertical plate 3 can be bonded, up to surfaces of both sides of the lower vertical plate thickness T2 that is in contact with or in proximity to the back side of the upper plate 1 are melted to form a penetration shape 23 having a melt-bonded part (welding metal part 7b) including the exposed bonding part 16 exposed to both corners of the back side of the upper plate 1 and the vertical plate 3. As a result, there is no non-bonded part on the side of the vertical plate 3, thereby enabling to increase the welding cross-sectional area and allowing simple evaluation by visual inspection of the welding bead appearance on the front side of the upper plate 1 and the bonded part appearance exposed at the corners on the back side.

Particularly, when forming a melt bonded part exposed to the corners of the back side of the upper plate 1 and the vertical plate 3, the arc welding is preferably performed while supplying a wire (not shown) to the arc welding part shown in FIG. 1C. The shortfall of the molten metal can be replenished, and an excellent welding bead with no recess or undercut on the welding surface can be obtained, by performing the wire feeding arc welding.

The welding cross-sectional area (multiplication of the penetration width and the welding length) on the back side penetration part of the upper plate 1 or a penetration width part on the side of the vertical plate 3 is formed equal to or greater than the plate thickness cross-sectional area on the side of the upper plate 1 or formed equal to or larger than the plate thickness cross-sectional are on the side of the vertical plate 3. Thus, as described, a welding metal part 7b having the tensile strength of equal to or stronger than the upper plate material strength or the vertical plate material strength can be obtained. The range of the upper plate thickness T1 is preferably set to 2≦T1≦7 mm, and melting and bonding from the surface of the upper plate 1 through the back side to the side of the lower vertical plate 3 enables to obtain the welding metal part 7b and a welding structure having a desired penetration shape 23.

If the upper plate thickness T1 is thinner than 2 mm, the welding deformation tends to increases due to the over melting on the side of the upper plate 1. On the other hand, if the upper plate thickness T1 is thicker than 7 mm, it is hard to melt from the surface of the upper plate 1 through the back side to the side of the lower vertical plate 3 and to obtain a sufficiently large penetration width w on the side of the vertical plate 3. A large-output arc welding apparatus is required to perform forcible melting, and the welding deformation tends to increase due to the over melting on the side of the upper plate 1, and thus, the forcible melting is not preferable.

The formation of 1 mm or more of the penetration depth h (see, FIG. 1C) on the side of the vertical plate 3 that is penetrated and welded from the surface of the upper plate 1 enables to obtain a sufficiently large penetration depth w and the welding cross-sectional area on the side of the vertical plate 3 that relate to the welding strength.

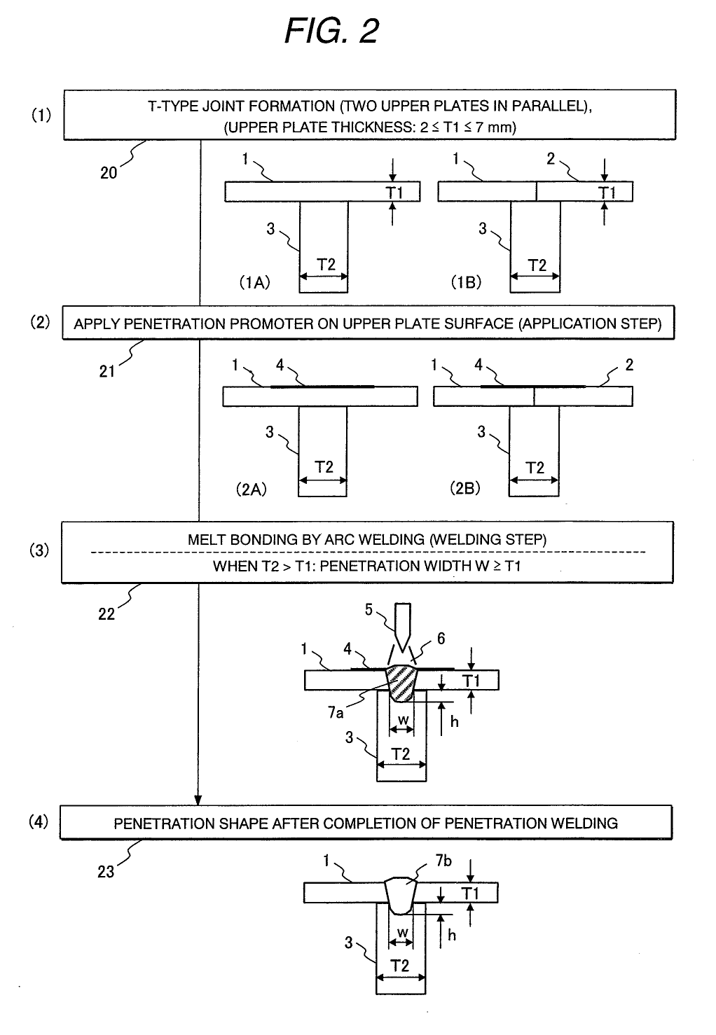

FIG. 2 is an explanatory view of another embodiment of a welding procedure and a penetration shape according to the penetration welding method of a T-type joint of the present invention. Principal differences from FIG. 1 are that the T-type joint is formed by arranging two upper plates 1a and 1b in parallel in a butted manner on the top surface of the lower vertical plate 3 and that the vertical plate thickness T2 of the T-type joint is thicker than the upper plate thickness T1 (T2>T1).

A joint to be welded is a T-type joint made of stainless steel or low carbon steel. The two upper plates 1a and 1b are arranged in parallel in a butted manner on the top surface of the lower vertical plate 3, and the upper plates 1a, 1b and the lower vertical plate 3 are melted and bonded. The range of the upper plate thickness T1 of the upper plates 1a and 1b is 2≦T1≦7 mm.

In the application step 21, as described, the penetration promoter 4 (fluxing material containing metal oxide) is applied by application means, such as a brush, to the surfaces of the upper plates 1a and 1b to be welded. When applying the penetration promoter 4, the applied film thickness in the weld line horizontal direction is preferably formed evenly by applying in the weld line direction of the surfaces of the upper plates 1a and 1b. The substantially symmetric, deep penetration shape 23 without offset or curvature can be obtained during the arc welding.

In the following welding step 22, the melting and bonding by the non-consumable electrode arc welding is performed from the surfaces of the upper plates 1a and 1b after application, as shown in FIG. 2C. When performing the arc welding, the melting and bonding is conducted so as to form the penetration width w on the side of the vertical plate 3 after penetrating through the back sides of the upper plates 1a and 1b to be equal to or greater than the upper plate thickness T1 (w≧T1) if the lower vertical plate thickness T2 is thicker than the upper plate thickness T1 (T2>T1).

By melting and bonding in such a manner, as described, the upper plates 1a, 1b and the lower vertical plate 3 can be rigidly melted and bonded, the welding cross-sectional area equal to or larger than the plate thickness cross-sectional area on the sides of the upper plates 1a and 1b can be obtained, and the welding metal part 7b having the tensile strength equal to or stronger than the upper plate material strength can be obtained, even if a flat plate T-type joint that is not beveled is used (see, FIG. 2D).

When a gap (not shown) exists at a butt part between the upper plates 1a and 1b shown in FIG. 2A, the arc welding is preferably performed while supplying a wire (not shown) to the arc welding part shown in FIG. 2C. The shortfall of the molten metal can be replenished, and an excellent welding bead with no recess or undercut on the welding surface can be obtained, by performing the wire feeding arc welding.

In the welding step 22, the non-consumable electrode arc welding is performed after applying the penetration promoter 4 on the surfaces of the upper plates 1a and 1b arranged on the top surface of the vertical plate 3 thicker than the upper plate thickness T1. As a result, the penetration width w on the side of the vertical plate 3 after penetrating through the back sides of the upper plates 1a and 1b can be formed equal to or greater than the upper plate thickness T1. Forming the penetration width w on the side of the vertical plate 3 to be equal to or greater than the upper plate thickness T1 in such a manner enables to obtain the welding cross-sectional area equal to or larger than the plate thickness cross-sectional area on the sides of the upper plates 1a and 1b, and obtain the welding metal part 7b having the tensile strength equal to or stronger than the upper plate material strength, as described.

When the lower vertical plate thickness T2 is the same thickness as the upper plate thickness T1 or thinner than the upper plate thickness T1 (T2≦T1), the welding cross-sectional area equal to or larger than the plate thickness cross-sectional area on the side of the vertical pate 3 can be obtained, and the welding metal part 7b having the tensile strength equal to or stronger than the vertical plate material strength can be obtained, by forming the penetration width w on the side of the vertical plate 3 to be equal to or greater than the vertical plate thickness T2 (w≧T2), as shown in FIGS. 1C and 1D.

In the penetration welding structure of the present invention, the penetration welding methods shown in FIG. 1 and FIG. 2 are carried out. The penetration welding structure comprises the welding metal part 7b in which the penetration width w on the side of the vertical plate 3 after penetrating through the back side of the upper plate 1 (1a and 1b) is formed equal to or greater than the vertical plate thickness T2 when the lower vertical plate thickness T2 is the same thickness as the upper plate thickness T1 or thinner than the upper plate thickness T1. The penetration welding structure comprises the welding metal part 7b in which the penetration width w is formed equal to or greater than the upper plate thickness T1 when the lower vertical plate thickness T2 is thicker than the upper plate thickness T1. This enables to rigidly bond the upper plate 1 (1a and 1b) and the lower vertical plate 3 and to obtain a sound welding metal part 7b and a welding structure having the welding cross-sectional area equal to or larger than the plate thickness cross-sectional area on the side of the upper plate 1 (1a and 1b) or the plate thickness cross-sectional area on the side of the vertical plate 3.

As in FIG. 1, the non-consumable electrode arc welding is performed after applying the penetration promoter 4 on the surfaces of the upper plates 1a and 1b arranged in parallel on the top surface of the vertical plate 3 thicker than the upper plate thickness T1. The penetration welding structure of the present invention comprises the welding metal part 7b in which the penetration width w on the side of the vertical plate 3 after penetrating through the back sides of the upper plates 1a and 1b is formed equal to or greater than the upper plate thickness T1. This enables to obtain a sound welding metal part 7b and a welding structure having the welding cross-sectional area equal to or larger than the plate thickness cross-sectional area on the sides of the upper plates 1a and 1b.

In the penetration welding structure, the welding cross-sectional area (multiplication of the penetration width and the welding length) of the back side penetration part of the upper plate 1 (1a and 1b) or the penetration width w part on the side of the vertical plate 3 is formed equal to or greater than the plate thickness cross-sectional area on the side of the upper plate 1 (1a and 1b) or formed equal to greater than the plate thickness cross-sectional area on the side of the vertical plate 3. Thus, as described, a welding metal part 7b and a welding structure having the tensile strength of equal to or greater than the upper plate material strength or the vertical plate material strength can be obtained. Especially, application to a welding structure of a T-type joint incorporated in a nuclear power device or other devices (for example, thermal power device) enables to reduce welding deformation, manpower, and costs, as compared to a conventional welding method and weldment.

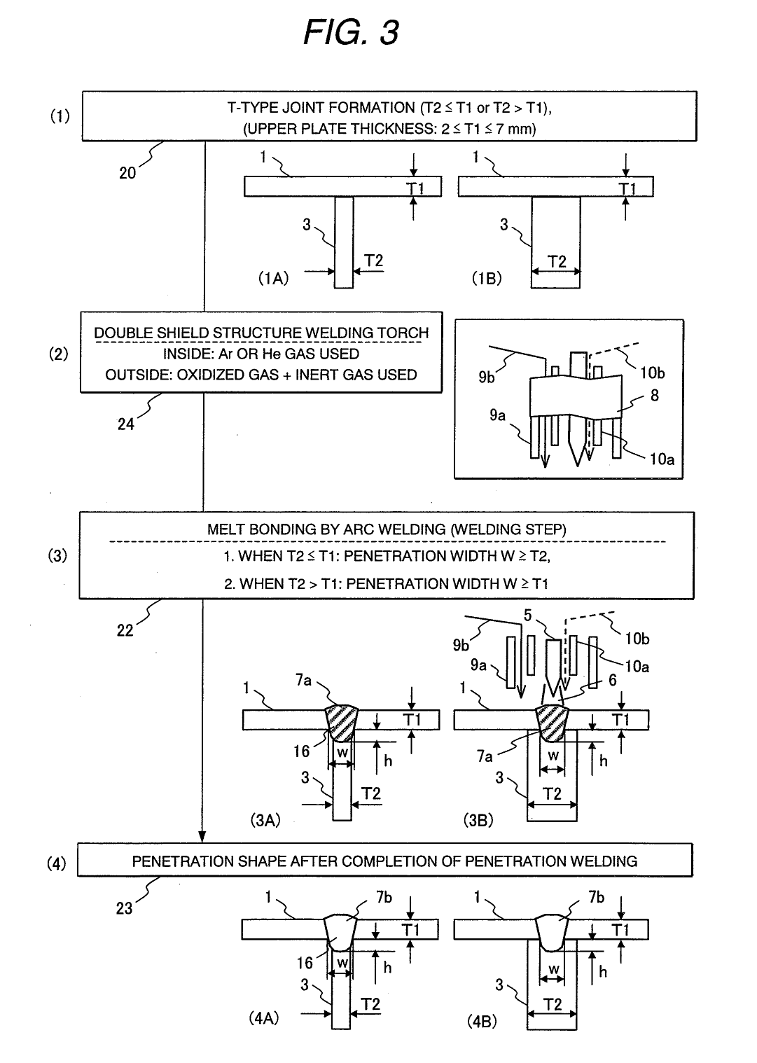

FIG. 3 is an explanatory view of still another embodiment of a welding procedure and a penetration shape according to the penetration welding method of a T-type joint of the present invention. The principal difference from FIG. 1 and FIG. 2 is that the non-consumable electrode arc welding is performed using a welding torch (shielding gas supply means) having a double shield structure that discharges a shielding gas made of an inert gas or a shielding gas containing an oxidized gas, without using the penetration promoter 4. The shape of the T-type joint or the penetration shape of the welded part is substantially the same as in FIG. 1.

More specifically, as shown in FIGS. 3B and 3C, a welding torch 8 having a double shield structure in which an inner pipe and an outer pipe are arranged coaxially is used, and melt-bonding by the arc welding is performed by discharging a mixed gas 9b of an oxidized gas (O₂ or CO₂) and an inert gas (Ar or He) from the nozzle hole of an outer nozzle 9a, and at the same time, discharging an inert gas 10b (Ar or He) from the nozzle hole of an inner nozzle 10a.

When performing the double shield arc welding, the penetration width w on the side of the vertical plate 3 after penetrating through the back side of the upper plate 1 is formed equal to or greater than the vertical plate thickness T2 (w≧T2) if the lower vertical plate thickness T2 is the same thickness as the upper plate thickness T1 or thinner than the upper plate thickness T1 (T2≦T1). The penetration width w on the side of the vertical plate 3 is formed equal to or greater than the upper plate thickness T1 (w≧T1) if the lower vertical plate thickness T2 is thicker than the upper plate thickness T1 (T2>T1). Therefore, as described, the upper plate 1 and the lower vertical plate 3 can be rigidly melted and bonded, either the welding cross-sectional area equal to or larger than the plate thickness cross-sectional area on the side of the vertical plate 3 or the welding cross-sectional area equal to or larger than the plate thickness cross-sectional area on the side of the upper plate 1 can be obtained, and a welding metal part 7b and a welding structure having a tensile strength equal to or stronger than the vertical plate material strength or the upper plate material strength can be obtained, even if a flat plate T-type joint that is not beveled is used.

When using a vertical plate thickness T2 (for example, T2≦T1) in which the entire surface on the side of the vertical plate 3 can be bonded, as described, up to surfaces of both sides of the lower vertical plate thickness T2 that is in contact with or in proximity to the back side of the upper plate 1 are melted to form a penetration shape 23 having a melt-bonded part exposed to both corners of the back side of the upper plate 1 and the vertical plate 3. As a result, there is no non-bonded part on the side of the vertical plate 3, thereby enabling to increase the welding cross-sectional area and allowing the evaluation by visual inspection of the quality of the welding bead appearance on the front side of the upper plate 1 and the bonded part appearance exposed at both corners of the back side. As described, the range of the plate thickness T1 of the upper plate 1 is preferably set to 223 T1≦7 mm, and melting and bonding from the surface of the upper plate 1 through the back side to the side of the lower vertical plate 3 enables to obtain a welding metal part 7b and a welding structure having a desired penetration shape 23.

As shown in FIG. 3, performing the double shield arc welding from the surface of the upper plate 1 arranged on the top surface of the vertical plate 3 thicker than the upper plate thickness T1 enables to form the penetration width w equal to or greater than the upper plate thickness T1, thereby allowing to surely obtain the welding cross-sectional area equal to or larger than the plate thickness cross-sectional area on the side of the upper plate 1, as described above.

If the arc welding is performed while pouring a mixed gas 9b of several percent of an oxidized gas (O₂ or CO₂) and an inert gas (Ar or He) into the arc welding part, the convection of the molten pool 7a right under the arc 6 changes in the depth direction to make the penetration deeper, allowing melting and bonding from the surface of the upper plate 1 to the side of the lower vertical plate 3. A known marketed product can be used as the mixed gas 9b of an oxidized gas and an inert gas.

Applying a shielding gas on the electrode 5 for forming the arc 6 and discharging the inert gas 10b (Ar or He) from the nozzle hole of the inner nozzle 10a can prevent oxidization and wear of the tip of the electrode 5 due to the oxidized gas. The use of the He gas high in the electrical gradient as an oxidized gas 10b increases the arc voltage and the heat input and increases the penetration amount, as compared to the use of an Ar gas. Therefore, for example, the penetration state is preferably appropriately adjusted by decreasing the welding current. The penetration width w on the side of the vertical plate 3 can be adjusted by setting up the welding heat input conditions such as welding current and welding speed. The melt-bonding by the arc welding is preferably performed by setting up appropriate welding conditions in advance so as to form the penetration width w equal to or greater than the upper plate thickness T1 (w≧T1) or equal to or greater than the vertical plate thickness T2 (w≧T2).

Performing the arc welding this way enables to melt from the surface of the upper plate 1 to the side of the lower vertical plate 3 and to rigidly bond the upper plate 1 and the lower vertical plate 3. As described, the welding cross-sectional area equal to or larger than the plate thickness cross-sectional area of the upper plate 1 or the plate thickness cross-sectional area of the vertical plate 3 can be obtained, and the welding metal part 7b having the tensile strength equal to or stronger than the upper plate material strength or the vertical plate material strength can be obtained. The double shield arc welding forms a convection type (and heat conduction type) penetration shape and does not generate spatter at all. Moreover, the double shield arc welding does not require implementation of a groove on the side of the upper plate 1, does not require installation of a backing material, and does not burn through. The double shield arc welding enables to reduce welding deformation, manpower, and costs, as compared to conventional TIG welding.

In the penetration welding structure of the present invention, the penetration welding method shown in FIG. 3 is carried out. The penetration welding structure may comprise a welding metal part 7b in which the penetration width w on the side of the vertical plate 3 after penetrating through the back side of the upper plate 1 is formed equal to or greater than the vertical plate thickness T2 when the lower vertical plate thickness T2 is the same thickness as the upper plate thickness T1 or thinner than the upper plate thickness T1. Meanwhile, the penetration welding structure may comprise a welding metal part 7b in which the penetration width w is formed equal to or greater than the upper plate thickness T1 when the lower vertical plate thickness T2 is thicker than the upper plate thickness T1. As described, this enables to rigidly bond the upper plate 1 and the lower vertical plate 3 and to obtain a sound welding metal part 7b and a welding structure having the welding cross-sectional area equal to or larger than the plate thickness cross-sectional area on the side of the upper plate 1 or the plate thickness cross-sectional area on the side of the vertical plate 3.

The penetration welding structure of the present invention may perform the double shield arc welding from the surface of the upper plate 1 arranged on the top surface of the vertical plate 3 thicker than the upper plate thickness T1 and may comprise a welding metal part 7b in which the penetration width w is formed equal to or greater than the upper plate thickness T1. This enables to obtain a sound welding metal part 7b and a welding structure having the welding cross-sectional area equal to or larger than the plate thickness cross-sectional area on the side of the upper plate 1. Especially, application to a welding structure of a T-type joint incorporated in a nuclear power device or other devices (for example, thermal power device) enables to reduce welding deformation, manpower, and costs, as compared to a conventional welding method and weldment.

### EXAMPLES

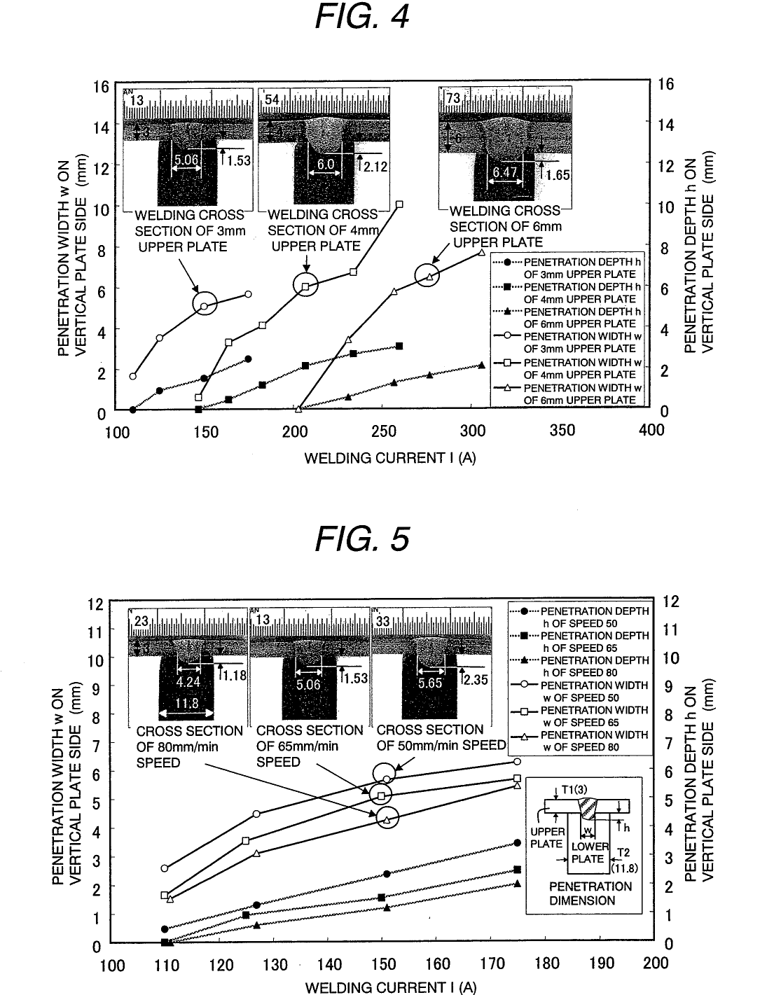

FIG. 4 depicts an example of the relationship of the welding current I with the penetration width w and the penetration depth h of each plate thickness on the vertical plate side when applying the welding method shown in FIG. 1 and FIG. 2. Representative cross-sectional photographs of each plate thickness are disclosed on the upper side of FIG. 4 in which welding is performed by changing the welding current I.

Three types of upper plates 1 are prepared having upper plate thicknesses T1 of 3, 4, and 6 mm (T1=3, 4, 6), and the vertical plate thickness 2 of the vertical plate 3 is made constant at 11.8 mm (T2=11.8), all of which are made of stainless steel (SUS304L). The welding speed (length of welding bead per minute) is made constant (65 mm/min), and the welding is performed by changing the welding current I for each plate thickness of the upper plate 1.

As can be seen from FIG. 4, the penetration width w and the penetration depth h on the side of the vertical plate 3 increase along with the increase in the welding current I. In the formation regions having 1 mm or more of the penetration depth h on the side of the vertical plate 3, every penetration width w is formed equal to or greater than the upper plate thickness T1. For example, the welding current I in which the penetration width w on the side of the vertical plate 3 is formed equal to or greater than the upper plate thickness T1 is about 125 A or more when the upper plate thickness is 3 mm, about 185 A or more when the upper plate thickness is 4 mm, and about 270 A when the upper plate thickness is 6 mm. The cross-sectional photographs of each plate thickness shown in FIG. 4 depict penetration shapes of parts where the penetration depth h on the side of the vertical plate 3 is about 1.5 to 2.1 mm, and in every cross-section, the penetration width w is formed equal to or greater than the upper plate thickness T1.

In this example, appropriate welding conditions such as a welding current corresponding to various plate thicknesses are set up to perform arc welding. Thus, the penetration width w equal to or greater than the upper plate thickness T1 is formed, enabling to obtain the welding metal part 7b in which the upper plate 1 and the lower vertical plate 3 are rigidly melt-bonded and the welding cross-sectional area equal to or larger than the plate thickness cross-sectional area of the upper plate 1.

FIG. 5 depicts another example of the relationship of the welding current I between the penetration width w and the penetration depth h on the side of the vertical plate 3 of each welding speed when applying the welding method shown in FIG. 1 and FIG. 2. Representative cross-sectional photographs in which welding is performed by changing the welding speed (three types, 50, 65, and 80 mm/min) are disclosed in the upper part of FIG. 5.

In another example, the upper plate thickness T1 of the upper plate 1 is constant at 3 mm (T1=3 mm), the vertical plate thickness T2 of the vertical plate 3 is constant at 11.8 mm (T2=11.8 mm), and the welding is performed by changing the welding speed and the welding current.

As can been seen from FIG. 5, the penetration width w and the penetration depth h on the side of the vertical plate 3 increase along with an increase in the welding current I or a decrease in the welding speed. In the formation regions with 1 mm or more of the penetration depth h on the side of the vertical plate 3, the penetration widths w are formed equal to or greater than the upper plate thickness T1.

In this case, the welding result of the T-type joint is shown in which the vertical plate thickness T2 (T2=11.8 mm) on the side of the vertical plate 3 is thicker than the vertical plate thickness T1 (T1=3 mm, T2>T1). However, when using a plate thickness about half the size, an excellent penetration shape can be obtained by decreasing the welding current or increasing the welding speed before welding.

As described, the penetration width w equal to or greater than the upper plate thickness T1 is formed by setting up appropriate welding conditions to perform arc welding. Thus, the welding metal part 7b in which the upper plate 1 and the lower vertical plate 3 are rigidly melt-bonded and the welding cross-sectional area equal to or larger than the plate thickness cross-sectional area of the upper plate 1 can be obtained.

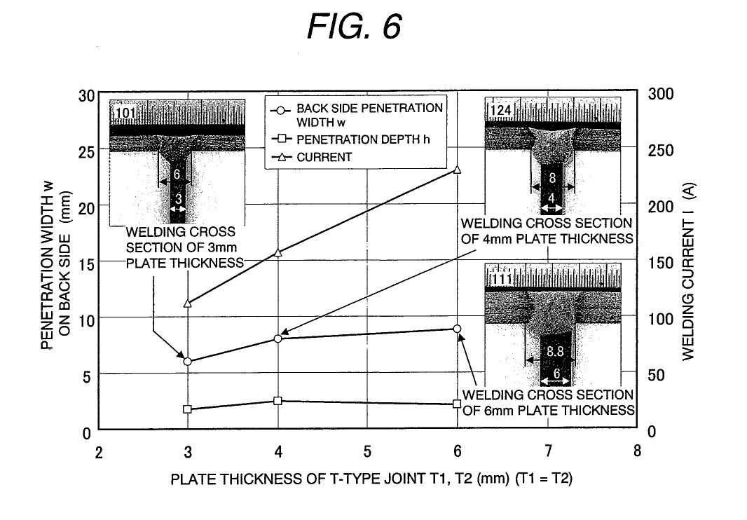

FIG. 6 depicts still another example of the relationship of the plate thickness (T1=T2) of the T-type joint with the welding current I, the penetration width w, and the penetration depth h when applying the welding method shown in FIG. 1.

In FIG. 6, representative cross-sectional photographs are disclosed in which the upper plate thickness T1 and the upper plate thickness T2 are the same (T1=T2), and various three types of plate thicknesses (T1=T2=3 mm, T1=T2=4 mm, and T1=T2=6 mm) are welded.

Appropriate welding conditions such as a welding current corresponding to the plate thickness of the T-type joint are set up to perform arc welding from the surface of the upper plate 1. Thus, a welding cross section of a penetration shape having a melt bonded part exposed to the corners of the back side of the upper plate 1 and the vertical plate 3 can be obtained. The penetration width w on the back side of the upper plate 1 of the T-type joint of each plate thickness is formed greater than the upper plate thickness T1 and the upper plate thickness T2, enabling to obtain the welding cross-sectional area larger than the plate thickness cross-sectional areas.

Although a small recess is generated on the welding surface of the upper plate 1 because the arc welding without wire feeding is performed in the still another example shown in FIG. 6, a welded part with no recess or undercut on the welding surface can be obtained by performing the wire feeding arc welding.

In this way, a penetration shape having a melt bonded part exposed to both corners of the back side of the upper plate 1, the vertical plate 3, and the T-type joint is formed. As a result, there is no non-bonded part on the side of the vertical plate 3, thereby enabling to increase the welding cross-sectional area and allowing simple evaluation by visual inspection of the quality of the welding bead appearance on the front side of the upper plate 1 and the bonded part appearance exposed at the corners of the back side.

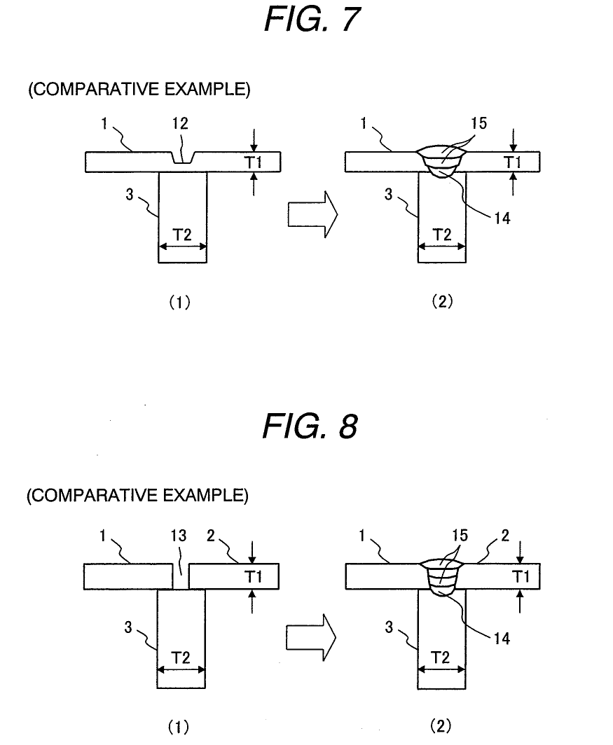

FIG. 7 is a cross-sectional view of an example of a multi-pass welding shape of a T-type joint with a bevel groove in a conventional TIG welding method. FIG. 8 is a cross-sectional view of another example of a multi-pass welding shape of another T-type joint with a gap in a conventional TIG welding method.

As shown in FIG. 7A, a bevel groove 12 is formed on the surface of the upper plate 1 to reduce the thickness of the upper plate 1 and the vertical plate 3 to facilitate melting, because the penetration is shallow in a convention TIG welding method. The reduced part of the bevel groove 12 is first welded for penetration up to the side of the vertical plate 3 to form a first layer welded part 14, and then the multi-pass welding is performed to sequentially laminate a plurality of laminate welded parts 15 up to the upper part of the upper plate 1.

As shown in FIGS. 8A and 8B, according to another method in the example, a large gap 13 of several millimeters is provided at the juncture of two upper plates 1 and 2 arranged in parallel, the bottom of the gap 13 and the space of the lower vertical plate 3 are welded for penetration up to the side of the vertical plate 3 to form the first layer welded part 14, and then the multi-pass welding is performed to sequentially laminate the plurality of laminate welded parts 15 up to the upper part of the groove.

Thus, the multi-pass welding that requires more manpower is needed in the conventional TIG welding according to the example, and the thermal deformation tends to increase.

On the other hand, as described, in the penetration welding method of a T-type joint of the present invention, a bevel groove or a joint gap need not be formed on the side of the upper plate 1, and one-pass welding with deep penetration can be performed. The welding metal part 7b in which from the surface of the upper plate 1 to the side of the lower vertical plate 3 is melted and in which the upper plate 1 and the lower vertical plate 3 are rigidly bonded can be obtained. The welding strength corresponding to the obtained welding cross-sectional area equal to or larger than the upper plate cross-sectional area or the vertical plate cross-sectional can also be obtained. Furthermore, welding deformation, manpower, and costs can be reduced as compared to a conventional welding method or a weldment.

Lastly, the measurement result of the deformation amount caused by welding and the tensile test result will be described.

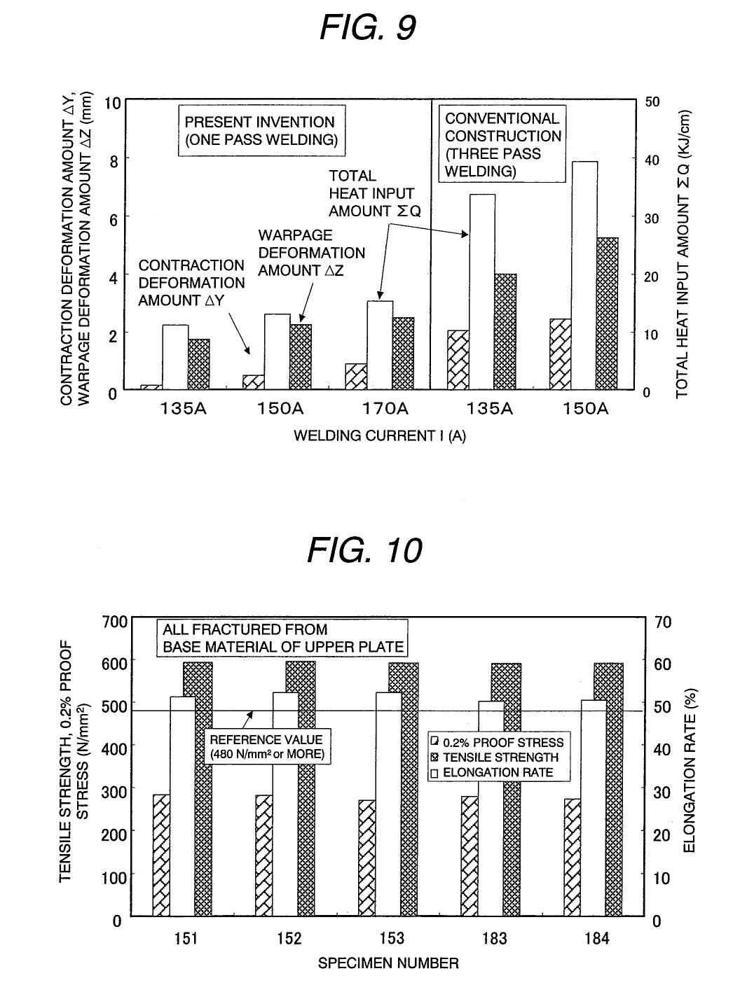

FIG. 9 depicts one example of a result of the comparison of the total heat input amount with the contraction deformation amount and the warpage deformation amount when constructed with the welding method of the present invention and with a conventional welding method. The horizontal axis denotes a shifted welding current (135 to 170 A), and the vertical axis denotes a total heat input amount of welding as well as a contraction deformation amount and a warpage deformation amount generated in the weld line horizontal width direction (plate width direction of the welding joint). The total heat input amount ΣQ is small in the welding method of the present invention compared to a conventional welding method, and the result shows that the warpage deformation amount ΔZ and the contraction deformation amount ΔY are small with ½ or less and ⅕ or less, respectively. This reveals that the one-pass welding of the present invention is more effective in drastically reducing the welding deformation.

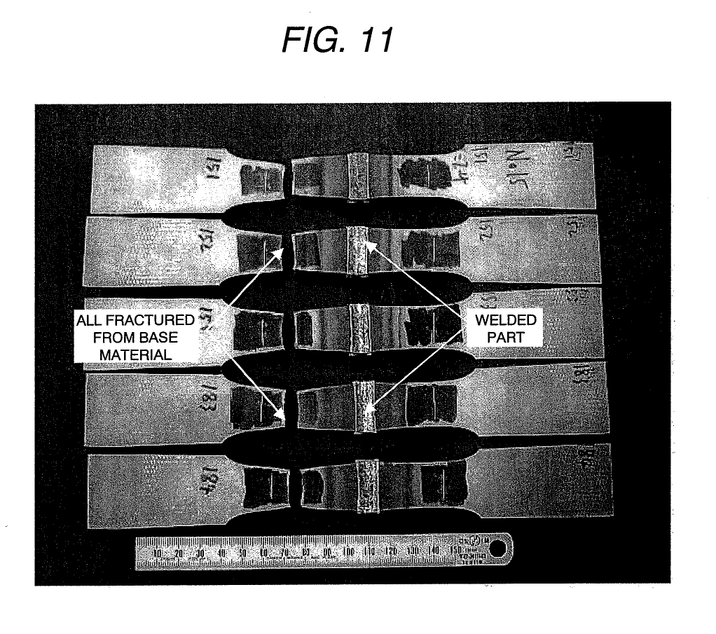

FIG. 10 depicts one example of the tensile result of T-type joint welding specimens (five specimens) having 3 mm upper plate thickness welded with the welding method of the present invention. FIG. 11 depicts a fracture specimen photograph after the tensile test, and a lower plate having 12 mm plate thickness remains bonded right under the welded part. An excellent result is obtained as can be seen from the tensile test result, in which all five specimens are fractured from the base materials of the upper plates, the tensile strength is 590 to 595 N/mm², exceeding the reference value (480 N/mm² or more), and the elongation rate of 50 mm gauge length across the welding parts is 50.2 to 52.2%.

What is claimed is:

1. A penetration welding method of a T-type joint made of stainless steel or low carbon steel that melts and bonds from a single-ply upper plate surface or two upper plate surfaces arranged in parallel in a butted manner on a lower vertical plate surface to a lower vertical plate,
wherein when performing non-consumable electrode arc welding after applying a penetration promoter on the upper plate surface, a penetration width w of the molten metal on the vertical plate side after penetrating through the upper plate back side is formed equal to or greater than a vertical plate thickness T2 if the lower vertical plate thickness T2 is the same as an upper plate thickness T1 or thinner than the upper plate thickness T1, or the penetration width w of the molten metal is formed equal to or greater than the upper plate thickness T1 if the lower vertical plate thickness T2 is thicker than the upper plate thickness T1.

2. A penetration welding method of a T-type joint made of stainless steel or low carbon steel that melts and bonds from a single-ply upper plate surface or two upper plate surfaces arranged in parallel in a butted manner on a lower vertical plate surface to a lower vertical plate, the penetration welding method comprising:
an application step of applying a penetration promoter on the upper plate surface in the weld line direction; and
a welding step of forming a penetration width w of the molten metal on the vertical plate side after penetrating through the upper plate back side to be equal to or greater than a vertical plate thickness T2 if the lower vertical plate thickness T2 is the same thickness as an upper plate thickness T1 or thinner than the upper plate thickness T1, or forming the penetration width w of the molten metal equal to or greater than the upper plate thickness T1 if the lower vertical plate thickness T2 is thicker than the upper plate thickness T1, when performing non-consumable electrode arc welding from the upper plate surface on which the penetration promoter is applied.

3. A penetration welding method of a T-type joint made of stainless steel or low carbon steel that melts and bonds from a single-ply upper plate surface or two upper plate surfaces arranged in parallel in a butted manner on a lower vertical plate surface to a lower vertical plate,
wherein when performing non-consumable electrode arc welding using shielding gas supply means for discharging a shielding gas made of an inert gas and a shielding gas containing an oxidized gas, a penetration width w of the molten metal on the vertical plate side after penetrating through the upper plate back side is formed equal to or greater than a vertical plate thickness T2 if the lower vertical plate thickness T2 is the same thickness as an upper plate thickness T1 or thinner than the upper plate thickness T1, or the penetration width w of the molten metal is formed equal to or greater than the upper plate thickness T1 if the lower vertical plate thickness T2 is thicker than the upper plate thickness T1.

4. The penetration welding method of a T-type joint according to claim 1, further comprising
a penetration shape formed on a vertical plate thickness T2 in which the entire surface on the vertical plate side can be bonded, the penetration shape melted up to surfaces of both sides of the lower vertical plate thickness T2 that is in contact with or in proximity to the upper plate back side, the penetration shape having a melt-bonded part between the upper plate back side and the vertical plate.

5. A penetration welding method of a T-type joint made of stainless steel or low carbon steel that melts and bonds from a single-ply upper plate surface or two upper plate surfaces arranged in parallel in a butted manner on a lower vertical plate surface to a lower vertical plate,
wherein non-consumable electrode arc welding using the shielding gas supply means for discharging a shielding gas made of an inert gas and a shielding gas containing an oxidized gas is performed from the upper plate surface arranged on a vertical plate surface thicker than the upper plate thickness T1 to form the penetration width w of the molten metal on the vertical plate side after penetrating through the vertical plate back side to be equal to or greater than the upper plate thickness T1.

6. A penetration welding method of a T-type joint made of stainless steel or low carbon steel that melts and bonds from a single-ply upper plate surface or two upper plate surfaces arranged in parallel in a butted manner on a lower vertical plate surface to a lower vertical plate,
wherein non-consumable electrode arc welding is performed after applying a penetration promoter on the upper plate surface arranged on the vertical plate surface thicker than the upper plate thickness T1 to form the penetration width w of the molten metal on the vertical plate side after penetrating through the vertical plate back side to be equal to or be greater than the upper plate thickness T1.

7. The penetration welding method of a T-type joint according to claim 1, wherein
the range of the upper plate thickness T1 is set to 2≦T1≦7 mm.

8. The penetration welding method of a T-type joint according to claim 1, wherein
the penetration depth h on the vertical plate side that is penetrated and welded at least from the upper plate surface is formed 1 mm or more.

9. The penetration welding method of a T-type joint according to claim 1, wherein
the molten metal having a predetermined penetration width w is formed in one pass.

10. A penetration welding structure of a T-type joint that is made of stainless steel or low carbon steel and that is melted and bonded from a single-ply upper plate surface or two upper plate surfaces arranged in parallel in a butted manner on a lower vertical plate surface to a lower vertical plate, wherein
the penetration welding method of a T-type joint of claim 1 is performed,
the penetration welding structure further comprising:
a welding metal part in which a penetration width w on the vertical plate side after penetrating through the upper plate back side is formed equal to or greater than the vertical plate thickness T2 if the lower vertical plate thickness T2 is the same thickness as the upper plate thickness T1 or thinner than the upper plate thickness T1; or
a welding metal part in which the penetration width w is formed equal to or greater than the upper plate thickness T1 if the lower vertical plate thickness T2 is thicker than the upper plate thickness T1.

11. The penetration welding structure of a T-type joint according to claim 10, wherein
the welding cross-sectional area of an upper plate back side penetration part or a penetration width part on the vertical plate side is formed equal to or larger than the plate thickness cross-sectional area on the upper plate side or formed equal to or greater than the plate thickness cross-sectional area on the vertical plate side.

12. A penetration welding structure of a T-type joint that is made of stainless steel or low carbon steel and that is melted and bonded from a single-ply upper plate surface or two upper plate surfaces arranged in parallel in a butted manner on a lower vertical plate surface to a lower vertical plate, the penetration welding structure further comprising
a welding metal part in which non-consumable electrode arc welding is performed after applying a penetration promoter on the upper plate surface arranged on the vertical plate surface thicker than the upper plate thickness T1 to form the penetration width w on the vertical plate side after penetrating through the vertical plate back side to be equal to or greater than the upper plate thickness T1.

13. A penetration welding structure of a T-type joint that is made of stainless steel or low carbon steel and that is melted and bonded from a single-ply upper plate surface or two upper plate surfaces arranged in parallel in a butted manner on a lower vertical plate surface to a lower vertical plate, the penetration welding structure further comprising
a welding metal part in which non-consumable electrode arc welding using shielding gas supply means for discharging a shielding gas made of an inert gas and a shielding gas containing an oxidized gas is performed from the upper plate surface arranged on a vertical plate surface thicker than the upper plate thickness T1 to form the penetration width w on the vertical plate side after penetrating through the vertical plate back side to be equal to or greater than the upper plate thickness T1.

14. The penetration welding structure of a T-type joint according to claim 10, wherein
the range of the upper plate thickness T1 is set to 2≦T1≦7 mm, and
the penetration depth h on the vertical plate side that is penetrated and welded at least from the upper plate surface is formed 1 mm or more.

15. The penetration welding structure of a T-type joint according to claim 10, wherein
the welding metal part is formed as a T-type joint applied at least to a nuclear power device or a thermal power device.
